(19) United States
(12) Patent Application Publication
(10) Pub. No.: US 2021/0229419 A1
(43) Pub. Date: Jul. 29, 2021

(54) TRANSFER MEMBER, IMAGE RECORDING APPARATUS, AND IMAGE RECORDING METHOD

(71) Applicant: CANON KABUSHIKI KAISHA, Tokyo (JP)

(72) Inventors: Mitsutoshi Noguchi, Kanagawa (JP); Yoshikazu Saito, Tokyo (JP); Yuichiro Kanasugi, Tokyo (JP); Tetsuya Kosuge, Kanagawa (JP); Tsukasa Sano, Kanagawa (JP); Midori Kushida, Tokyo (JP); Yukari Sumioka, Kanagawa (JP); Akira Goto, Kanagawa (JP)

(21) Appl. No.: 17/156,948

(22) Filed: Jan. 25, 2021

(30) Foreign Application Priority Data
Jan. 27, 2020 (JP) 2020-010861
Jan. 21, 2021 (JP) 2021-007993

(51) Int. Cl. B41J 2/005; B41J 2/325

(52) U.S. Cl. CPC B41J 2/0057; B41J 2/325

(57) ABSTRACT

A transfer member according to the present invention includes an elastic layer, and a compression layer, in which the elastic layer contains a thermally conductive filler having thermal conductivity of 5 [W/m·K] or more, and when a compressive elastic modulus of the elastic layer is defined as E1 [MPa], thermal conductivity of the elastic layer is defined as λ1 [W/m·K], a compressive elastic modulus of the compression layer is defined as E2 [MPa], and thermal conductivity of the compression layer is defined as λ2 [W/m·K], 1≤E1≤50, E2≤10, 0.25≤λ1, and λ2≤0.2 are satisfied.

### BACKGROUND OF THE INVENTION

### Field of the Invention

The present invention relates to a transfer member, an image recording apparatus, and an image recording method.

### Description of the Related Art

A transfer type image recording method for forming an intermediate image on an image formation surface of a transfer member, and transferring the intermediate image to a recording medium is known.

Japanese Patent Application Laid-Open No. H07-32721 proposes an image recording method of containing resin fine particles in an ink composition and heating a transfer member to a temperature equal to or higher than a minimum film formation temperature of the resin fine particles to transfer the transfer member. Further, as the transfer member, one in which a rubber material is stacked on metal has been proposed.

### SUMMARY OF THE INVENTION

The present invention is intended for a transfer member having excellent transferability of an intermediate image to a recording medium and improved durability. In addition, an object of the present invention is to provide an image recording apparatus and an image recording method using the transfer member.

According to one aspect of the present invention, there is provided a transfer member including an elastic layer and a compression layer, in which the elastic layer contains a thermally conductive filler having thermal conductivity of 5 [W/m·K] or more, when a compressive elastic modulus of the elastic layer is defined as E1 [MPa], thermal conductivity of the elastic layer is defined as λ1 [W/m·K], a compressive elastic modulus of the compression layer is defined as E2 [MPa], and thermal conductivity of the compression layer is defined as λ2 [W/m·K], 1≤E1≤50, E2≤10, 0.25≤λ1, and λ2≤0.2 are satisfied.

In addition, according to another aspect of the present invention, there is provided an image recording apparatus including a transfer member, an intermediate image forming unit that forms an intermediate image on a surface of the transfer member, a heating unit that heats the intermediate image by heating the transfer member, and a transfer unit that transfers the heated intermediate image from the transfer member to a recording medium, in which the transfer member is the transfer member.

In addition, according to another aspect of the present invention, there is provided an image recording method including an intermediate image forming step of forming an intermediate image on a surface of a transfer member, a heating step of heating the intermediate image by heating the transfer member, and a transferring step of transferring the heated intermediate image from the transfer member to a recording medium, in which the transfer member is the transfer member.

Further features of the present invention will become apparent from the following description of exemplary embodiments with reference to the attached drawings.

### BRIEF DESCRIPTION OF THE DRAWINGS

FIG. 1 is a schematic view illustrating a configuration of a transfer member according to an embodiment of the present invention.

FIG. 2 is a schematic view illustrating a configuration of an image recording apparatus according to an embodiment of the present invention.

### DESCRIPTION OF THE EMBODIMENTS

In the transfer type image recording method, the transferability of the intermediate image is improved by heating the resin fine particles in the ink composition applied onto the transfer member to a temperature equal to or higher than the minimum film formation temperature. Therefore, the image formation surface of the transfer member may be damaged due to the repeated load applied by the series of image recording processes. In particular, when a defective portion is generated on the surface of the transfer member, the image quality of the intermediate image may be deteriorated or the transferability to a recording medium may be deteriorated.

Therefore, the present inventors have excellent transferability of the intermediate image to the recording medium, have made diligent studies to improve the durability, and therefore, have reached the present invention.

Hereinafter, the present invention will be described in detail with reference to examples of an exemplary embodiment.

First, a configuration of the transfer member will be described.

In order to exhibit the transferability to the recording medium, the surface of the transfer member can have high followability to the recording medium. On the other hand, in a case where the followability is excessively high, a stress due to deformation becomes large, so that there is a high concern that damage to the surface of the transfer member may occur. Therefore, in order to achieve both transferability and durability of the transfer member, it is necessary to appropriately control the compressive elastic modulus of the elastic layer of the transfer member. However, the present inventors have found that in order to further improve the transferability and durability of the transfer member, it is important to control not only the compressive elastic modulus of the elastic layer, but also appropriately control the compressive elastic modulus of the compression layer and the thermal conductivity of the elastic layer and the compression layer, and have reached the present invention. Specifically, a compressive elastic modulus E1 of the elastic layer was set to 1 MPa or more and 50 MPa or less, while a compressive elastic modulus E2 of the compression layer was set to 10 MPa or less. With this, not only the elastic layer but also the compression layer can suppress the load of pressure on the surface of the transfer member, and as a result, the damage to the surface of the transfer member can be suppressed. Further, by setting thermal conductivity λ1 of the elastic layer to 0.25 W/m·K or more and thermal conductivity λ2 of the compression layer to 0.2 W/m·K or less, heat imparted from the image formation surface side of the transfer member can be efficiently held in the elastic layer, and the temperature controllability of the surface of the transfer member can be improved.

Further, in a case where the image recording process is repeated, in the image recording method of the present invention, it is preferable to control the temperature within an appropriate temperature range in each step for transferability and image quality, and in order to exhibit the temperature controllability, the thermal conductivity can be controlled. By appropriately performing this control, for example, it is possible to adjust the temperature to a range necessary for the exhibition of transferability without excessively increasing the temperature during a transferring step, and it is possible to improve the transferability during repetition.

### <Transfer Member>

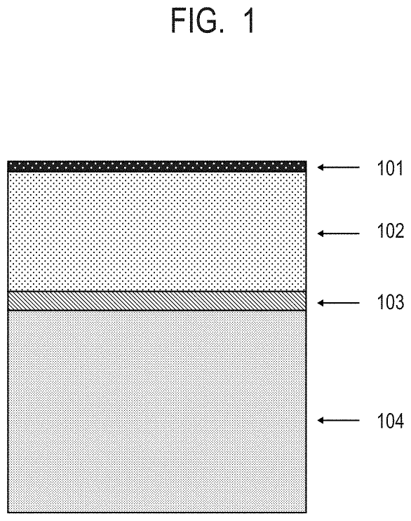

The transfer member in the present invention may be used in a transfer type image recording apparatus in a state of being supported by a support member, if necessary. FIG. 1 is a schematic view illustrating a configuration of a transfer member according to an embodiment of the present invention. In FIG. 1, 101 is a surface layer, 102 is an elastic layer, 103 is an intermediate layer, and 104 is a compression layer.

In the transfer type image recording apparatus, in order to improve the transferability of the intermediate image at the time of transferring the intermediate image to a recording medium, a transfer member including an intermediate image on the surface (image formation surface) is heated by a heating device (heating unit). At that time, a resin, a resin particle, or the like contained in the intermediate image on the transfer member is melted, and the adhesiveness of the intermediate image to the recording medium is improved. When the surface of the transfer member has high followability to the recording medium, the adhesiveness is improved, and as a result, the transferability of the intermediate image to the recording medium can be improved. The followability and adhesiveness can also be improved by controlling the pressure and temperature during the transferring step. However, in the above-described image recording apparatus, in a case where the transfer member is repeatedly subjected to excessive pressurization or heating during the transferring step, damage may occur on the surface of the transfer member, and a decrease in the transferability may be observed. Then, the present inventors have estimated that causes of these phenomena occur in combination of a physical damage to the transfer member due to pressurization of the transfer member, and a chemical damage to the transfer member due to heating of chemicals such as ink and a reaction liquid to form an intermediate image.

The size of the transfer member can be freely selected according to a target print image size. Examples of the overall shape of the transfer member include a sheet shape, a roller shape, a drum shape, a belt shape, and an endless web shape.

The transfer member of the present invention can be installed on a support member. As an installation method, various adhesives or adhesive tapes may be used. Alternatively, by attaching an installation member made of a metal, ceramic, resin, or the like to the transfer member, the transfer member may be fixed and held on the support member using the installation member.

The transfer member in the present invention includes at least an elastic layer and a compression layer.

### (Elastic Layer)

As a material for forming the elastic layer, various rubber materials or various elastomer materials can be used from the viewpoint of processing characteristics and the like, and the elastic layer can be provided in the form of a continuous layer or a porous layer. Examples of the elastomer material and rubber material include a silicone rubber, a fluorosilicone rubber, a phenylsilicone rubber, a fluororubber, a chloroprene rubber, a nitrile rubber, an ethylenepropylene rubber, and a natural rubber. Other examples include a styrene rubber, an isoprene rubber, a butadiene rubber, an ethylene/propylene/butadiene copolymer, a nitrile butadiene rubber, and an acrylic rubber. In particular, a silicone rubber, a fluorosilicone rubber, a phenylsilicone rubber, a fluororubber, an acrylic rubber, and a chloroprene rubber are preferably used from the viewpoint of dimensional stability, durability, heat resistance, and the like.

Further, the elastic layer can contain a thermally conductive filler for controlling the thermal conductivity from the viewpoint of temperature control. In order to improve the thermal conductivity, for example, alumina, magnesium oxide, boron nitride, metallic silicon, aluminum nitride, silicon carbide, and crystalline silica can be used as the thermally conductive filler.

In particular, in a case where water is used as a material used for forming the intermediate image, or in a case where the adhesion of the interface between the thermally conductive filler and the material forming the elastic layer is low, repeated use may cause damage to the transfer member. As a result of the studies by the present inventors, it has been found that the thermally conductive filler can contain metallic silicon from the viewpoint of achieving both temperature controllability and durability.

Further, from the viewpoint of pressure uniformity, the thermally conductive filler can contain alumina. Further, alumina can be subjected to an optional silane coupling treatment from the viewpoint that the adhesion of an interface between the thermally conductive filler and the elastic layer material can be improved. Further, the thermally conductive filler preferably has a small particle size from the viewpoint of dispersion uniformity of the elastic layer material. An average particle size of the thermally conductive filler is, for example, 10 μm or less, more preferably 8 μm or less, and further preferably 5 μm. By reducing the average particle size, in a case where the pressure is applied to the surface of the elastic layer in the transferring step or the like, it is possible to prevent the pressure from being locally concentrated and causing damage.

Here, it is important that the thermal conductivity of the thermally conductive filler is 5 W/m·K or more. In addition, the thermal conductivity of the thermally conductive filler is preferably 30 W/m·K or more, and more preferably 100 W/m·K or more.

The content of the thermally conductive filler contained in the elastic layer is not particularly limited, but can be determined in consideration of the followability to the recording medium, which is a function of the elastic layer, and the durability against a load such as pressure. Specifically, the elastic layer can contain the thermally conductive filler in an amount of 1% by mass or more and 70% by mass or less based on the total mass of the elastic layer, and more preferably 5% by mass or more and 60% by mass or less. By setting the content of the thermally conductive filler in the above range, the thermal conductivity of the elastic layer can be improved, a surface damage is less likely to occur, and the durability is improved.

When the thermal conductivity of the elastic layer is set to λ1 [W/m·K], 0.25≤λ1 is preferable, and 0.5≤λ1 is more preferable.

When 0.25≤λ1 is satisfied, the temperature controllability of the surface of the transfer member is high, and in repeated use, it is possible to control the temperature within an appropriate temperature range during the transferring step, and thereby it is possible to suppress a decrease in transferability.

Further, in order to control the temperature from the image formation surface side, heating by irradiation with near infrared rays having a wavelength of 900 nm or more and 2500 nm or less may be used. In this case, the elastic layer can contain an additive capable of absorbing the irradiated near-infrared rays (hereinafter, also referred to as “additive for absorbing near-infrared rays”). Specific examples of the additive for absorbing near-infrared rays include organic dyes such as phthalocyanine dyes, a dithiolene complex compound (metal complex having a dithiolene ligand), squarylium dyes, quinone dyes, and a diimmonium compound, and an organic compound. In addition, inorganic materials such as carbon black, iron oxide, alumina, iron, aluminum, and silicon can also be mentioned. In particular, carbon black can be usefully applied from the viewpoint of cost. Organic dyes can be used in the form of dyes or pigments, depending on the types thereof. In addition, the inorganic material can be used as a form as an inorganic filler such as a particulate or fibrous form. Examples of the inorganic filler made of a carbon material include carbon nanotubes.

The content of the additive for absorbing near-infrared rays in the elastic layer is not particularly limited as long as it is set so as to obtain the desired endothermic and heat storage effects according to the types of the additives. The absorption rate of near infrared rays with respect to wavelength of 900 nm or more and 2500 nm or less of the elastic layer is preferably 60% or more, and more preferably 80% or more. Therefore, it is preferable to add the additives so that the absorption rate of near infrared rays with respect to a wavelength of 900 nm or more and 2500 nm or less of the elastic layer is 60% or more, and the elastic layer can contain the additives for absorbing near-infrared rays so that the absorption rate is 80% or more. From such a viewpoint, the content of the additive for absorbing near-infrared rays in the elastic layer is preferably 1% by mass or more and 90% by mass or less.

When the compressive elastic modulus of the elastic layer is set to E1 [MPa], it is important that 1≤E1≤50 is satisfied. Further, E1 can satisfy 3≤E1≤25. By setting the compressive elastic modulus E1 of the elastic layer to 1 MPa or more, it becomes easy to follow the recording medium while suppressing large deformation of the elastic layer. Further, by setting the compressive elastic modulus E1 of the elastic layer to 50 MPa or less, in particular, the stress locally applied to the surface layer at high speed can be sufficiently relaxed by the elastic layer, and the damage to the surface can be reduced.

When the thickness of the elastic layer is defined as t1 [mm], 0.03≤t1≤0.2 can be satisfied. By setting t1 to 0.03 mm or more, the followability to the recording medium during the transferring step is improved, and the transferability is improved. By setting t1 to 0.2 mm or less, the temperature controllability of the elastic layer is improved, and even in repeated use, it is possible to control the temperature within an appropriate temperature range during the transferring step, thereby improving the transferability.

### (Compression Layer)

The compression layer in the present invention generates a transfer pressure due to a compression strain. Examples of members of the compression layer include an acrylonitrile/butadiene rubber, an acrylic rubber, a chloroprene rubber, a urethane rubber, a silicone rubber, a fluororubber, and an ethylene/propylene/diene rubber. Further, a porous rubber material can be used. For example, when molding a rubber material, a predetermined amount of a vulcanizing agent, a vulcanization accelerator, and the like are blended, and a filler such as an antifoaming agent, a hollow fine particle, or salt is further blended if necessary to make a porous rubber material. Further, the compression layer in the present invention can absorb the deformation of the surface of the transfer member, disperse the fluctuation against local pressure fluctuations, and maintain excellent transferability even during high-speed printing. In particular, in a case where a porous rubber material is used, since a bubble portion is compressed with a volume change in response to various pressure fluctuations, deformation in directions other than the compression direction is small, and more stable transferability and durability can be obtained. Examples of the porous rubber material include a porous rubber material having a continuous pore structure in which pores are continuous with each other and a porous rubber material having an independent pore structure in which each pore is independent. In the present invention, any structure may be used, and these structures may be used in combination.

Further, when the compressive elastic modulus of the compression layer is defined as E2 [MPa], E2≤10 can be satisfied in order to generate an appropriate transfer pressure. By setting the compressive elastic modulus E2 of the compression layer to 10 MPa or less, the pressure load applied to the surface of the transfer member is suppressed, and the occurrence of damage to the surface is suppressed.

When the thermal conductivity of the compression layer is defined as λ2 [W/m·K], λ2≤0.2 can be satisfied. By setting the thermal conductivity λ2 of the compression layer to 0.2 W/m·K or less, the heat applied from the image formation surface side can be efficiently stored in the elastic layer. With this, the temperature controllability of the surface of the elastic layer is improved, and even in repeated use, it is possible to control the temperature within an appropriate temperature range during the transferring step, thereby improving the transferability.

When the thickness of the compression layer is defined as t2 [mm], 0.1≤t2≤0.6 can be satisfied. By setting the thickness t2 of the compression layer to 0.1 mm or more, the pressure change with respect to the amount of compression strain can be reduced, the pressure load applied to the surface of the transfer member can be reduced, and the occurrence of damage to the surface can be suppressed. Further, by setting the thickness t2 of the compression layer to 0.6 mm or less, the amount of compression strain for generating an appropriate transfer pressure can be reduced, and damage can be suppressed even if the deformation stress on the surface becomes large.

### (Base Layer)

The transfer member in the present invention can include a base layer below the compression layer in order to impart the transportability and mechanical strength. Specifically, the base layer can be provided on the surface of the compression layer opposite to the surface facing the elastic layer. In a case where the transfer member includes the base layer, the transfer member can include an elastic layer, a compression layer, and a base layer in this order from the surface (image formation surface) side of the transfer member. As a material constituting the base layer, a woven fabric made of natural fibers such as metal, ceramics, resin, cotton, or synthetic fibers thereof can be used.

In particular, the base layer can contain at least one selected from the group consisting of a woven fabric containing cellulose fibers and a non-woven fabric containing cellulose fibers.

In a case where the transfer member has a drum shape, an embodiment in which the compression layer and the elastic layer are formed on the support member without the base layer may be employed.

### (Intermediate Layer)

In FIG. 1, an intermediate layer 103 can be included between an elastic layer 102 and a compression layer 104. The deformation behavior of the elastic layer 102 can be controlled by the intermediate layer 103. As described above, the elastic layer 102 and the compression layer 104 are formed so as to have followability to the recording medium, generation of transfer pressure, and temperature controllability in order to exhibit the transferability of the intermediate image. Further, as described above, the elastic layer 102 and the compression layer 104 are mainly formed of a rubber material or an elastomer material. The deformation behavior of the elastic layer 102 is related to damage to the image formation surface and may affect the durability during repeated use. In order to improve the durability, the deformation behavior of the elastic layer 102 can be the minimum deformation within the range in which the transferability can be exhibited, but by including an intermediate layer 103, the controllability of the deformation behavior of the elastic layer can be improved.

Here, when the compressive elastic modulus of the intermediate layer is defined as E3 [MPa], 1000≤E3≤7000 can be satisfied. By setting the compressive elastic modulus E3 of the intermediate layer to be in this range, the deformation behavior of the elastic layer is suppressed and the durability is improved.

Further, when the thickness of the intermediate layer is defined as t3 [mm], 0.003≤t3≤0.05 can be satisfied. By setting the thickness t3 of the intermediate layer to 0.003 mm or more, the influence on the deformation behavior of the elastic layer can be suppressed. Further, by setting the thickness t3 of the intermediate layer to 0.05 mm or less, the elastic layer is subjected to the deformation behavior and the durability is improved.

Further, when the thermal conductivity of the intermediate layer is defined as λ3 [W/m·K], 0.1≤λ3≤0.5 can be satisfied. The transferability can be improved by controlling the thermal conductivity λ3 of the intermediate layer within this range.

As the intermediate layer, for example, a polyester resin such as polyethylene terephthalate and polyethylene naphthalate, polycarbonate, polyimide, polyamide, polyphenylene sulfide, acrylic and the like can be preferably used.

### (Surface Layer)

Further, in FIG. 1, a surface layer 101 can be provided on the intermediate image formation surface of the elastic layer 102. That is, the transfer member can include a surface layer, an elastic layer, a compression layer, and a base layer in this order from the surface (image formation surface) side of the transfer member. As a material constituting the surface layer, various materials such as resin and ceramics can be appropriately used.

In addition, when the thickness of the surface layer is defined as t4 [mm], 0.001≤t4≤0.015 can be satisfied. By setting the thickness t4 of the surface layer to 0.001 mm or more, the surface damage is suppressed during the transferring step and the durability is improved. Further, by setting the thickness t4 of the surface layer to 0.015 mm or less, the uniformity of pressure on the surface of the recording medium is maintained during the transferring step, and the transferability is improved.

Examples of the resin used for the surface layer include an acrylic resin, an acrylic silicone resin, and a fluorine-containing resin. Examples of the ceramic include a condensate of a hydrolyzable organosilicon compound.

Examples of other materials that can be used for forming the surface layer include a compound obtained by hydrolysis and polycondensation of metal alkoxides, and an inorganic compound generally obtained by a sol-gel method. Examples of the metal alkoxide include a compound represented by a General formula: M(OR)n (M is metal such as silicon, titanium, zirconium or aluminum, and R represents an alkyl group).

Among these, a condensate of a hydrolyzable organosilicon compound is preferable from the viewpoint of the image forming property and transferability by ink. Further, a condensate of a hydrolyzable organosilicon compound having a polymerization structure by cation polymerization, radical polymerization or the like is more preferable from the viewpoint of the durability.

Since the surface layer has a molecular structure containing a siloxane bond derived from a hydrolyzable organosilicon compound, it is presumed that the components imparted by the ink constituting the intermediate image effectively spreads to the image formation surface of the surface layer, and thereby the transferability is improved. In addition, it is presumed that the intermediate image can be easily peeled off from the transfer member and the transferability is improved.

Specific examples of the hydrolyzable organosilicon compound include the following materials, but the present invention is not limited thereto. Examples thereof include glycidoxypropyl trimethoxy silane, glycidoxypropyl triethoxy silane, glycidoxypropyl methyl dimethoxy silane, and glycidoxypropyl methyl diethoxy silane. Examples thereof include glycidoxypropyl dimethyl methoxy silane, glycidoxypropyl dimethyl ethoxy silane, 2-(epoxycyclohexyl) ethyl trimethoxy silane, and 2-(epoxycyclohexyl) ethyl triethoxy silane. Then, a compound in which the epoxy group of these compounds is substituted with an oxetanyl group can also be mentioned. Further, examples thereof include acryloxypropyl trimethoxy silane, acryloxypropyl triethoxy silane, acryloxypropyl methyl dimethoxy silane, acryloxypropyl methyl diethoxy silane, and acryloxypropyl dimethyl methoxy silane. Further, examples thereof include acryloxypropyl dimethyl ethoxy silane, methacryloxypropyl trimethoxy silane, methacryloxypropyl triethoxy silane, methacryloxypropyl methyl dimethoxy silane, and methacryloxypropyl methyl diethoxy silane. In addition, examples thereof include methacryloxypropyl dimethyl methoxy silane, methacryloxypropyl dimethyl ethoxy silane, methyl trimethoxy silane, methyl triethoxy silane, dimethyl dimethoxy silane, and dimethyl diethoxy silane. Further, examples thereof include trimethyl methoxy silane, trimethyl ethoxy silane, propyl trimethoxy silane, propyl triethoxy silane, hexyl trimethoxy silane, hexyl triethoxy silane, decyl trimethoxy silane, and decyl triethoxy silane can be mentioned. The surface layer can be formed by one kind selected from the above-described materials or in combination of two or more kinds thereof.

The surface layer can contain these resins and ceramics in a total amount of 10% by mass or more and 100% by mass or less. Further, it is more preferably contained in an amount of 30% by mass or more, and further preferably contained in an amount of 50% by mass or more. The surface layer can contain various fillers and additives within the above range.

When the compressive elastic modulus of the surface layer is defined as E4 [MPa], 10≤E4≤300 can be satisfied. By setting the compressive elastic modulus E4 of the surface layer to 10 MPa or more, surface damage during repeated use can be reduced. Further, by setting the compressive elastic modulus E4 of the surface layer to 300 MPa or less, it is possible to have the followability to the recording medium and to exhibit the transferability.

Further, when the thermal conductivity of the surface layer is defined as λ4 [W/m·K], the above characteristics can be exhibited by satisfying 0.1≤λ4≤0.5.

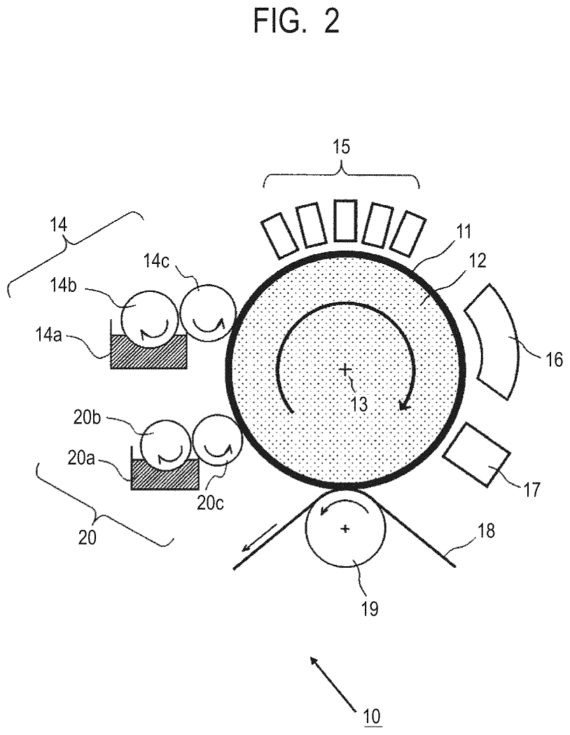

FIG. 2 illustrates a schematic configuration of an image recording apparatus according to an embodiment of the present invention. This image recording apparatus includes a transfer member, an intermediate image forming unit that forms an intermediate image on a surface of the transfer member, a heating unit that heats the intermediate image by heating the transfer member, and a transfer unit that transfers the heated intermediate image from the transfer member to a recording medium. In the image recording apparatus 10 of FIG. 2, the transfer member 11 is disposed on an outer peripheral surface of a rotatable drum-shaped support member 12. The transfer member 11 is rotationally driven in the direction of the arrow, and in synchronization with the rotation, each device disposed in the periphery operates. The form of the transfer member 11 may be any shape as long as the image formation surface can come into contact with the recording medium 18, and may be, for example, a roller shape or an endless belt shape according to the form of the image recording apparatus to be applied or the transfer conditions to the recording medium can be preferably used.

### <Image Recording Method>

The outline of the image recording method according to the present embodiment will be described below. First, image data is transmitted from an image data supply device (not shown), and the image recording apparatus 10 is instructed to perform image recording. Then, the image data is subjected to necessary image processing for forming an image by an ink applying device 15 provided with an ink jet recording head.

### [Intermediate Image Forming Step]

An intermediate image forming step is a step of applying ink to the surface of the transfer member to form an intermediate image. Further, the intermediate image forming step can include a step of applying a reaction liquid containing a component for increasing the viscosity of the ink to the surface of the transfer member. That is, the intermediate image forming step can include a reaction liquid applying step of applying a reaction liquid containing a component that increases the viscosity of the ink to the surface of the transfer member, and an ink applying step of applying ink to the surface of the transfer member to form an intermediate image.

The reaction liquid can be applied at least before the application of the ink and after the application of the ink. The ink and the reaction liquid are applied to the image formation surface of the transfer member so that at least some of these overlap with each other. In order to increase the viscosity of the ink with the reaction liquid more effectively, the ink can be applied to the image formation surface of the transfer member to which the reaction liquid is applied.

### (Reaction Liquid)

The reaction liquid contains a component that increases the viscosity of the ink used in the image recording method of the present invention (hereinafter, may be referred to as an “ink high viscosity component”). Here, the high viscosity of the ink means a case where a coloring material and a resin constituting the ink chemically react or physically adsorb when these come into contact with the ink high viscosity component, and thus an increase in the viscosity is observed in the entire ink. Further, the present invention is not limited to this case, and includes a case where a part of the ink composition such as a coloring material aggregates to cause a local increase in the viscosity. Here, the “reaction” in the “reaction liquid” includes not only a chemical reaction between the inks but also a physical action (adsorption and the like). The ink high viscosity component has an effect of reducing the fluidity of a part of the ink and/or the ink composition on the transfer member and suppressing bleeding and beading during the image formation.

As the ink high viscosity component, known substances in the related art, such as polyvalent metal ions, organic acids, cationic polymers, and porous fine particles can be used without particular limitation. Among these, polyvalent metal ions and organic acids are particularly preferable. It is also preferable to contain a plurality of types of ink high viscosity components. The content of the ink high viscosity component in the reaction liquid is preferably 5% by mass or more with respect to the total mass of the reaction liquid.

Examples of the metal ions that can be used as the ink high viscosity component include divalent metal ions such as Ca²⁺, Cu²⁺, Ni²⁺, Mg²⁺, Sr²⁺, Ba²⁺, and Zn²⁺, and trivalent metal ions such as Fe³⁺, Cr³⁺, Y³⁺, and Al³⁺.

Examples of organic acids that can be used as the ink high viscosity component include oxalic acid, polyacrylic acid, formic acid, acetic acid, propionic acid, glycolic acid, malonic acid, malic acid, maleic acid, ascorbic acid, levulinic acid, succinic acid, glutaric acid, and glutamic acid. Examples thereof also include fumaric acid, citric acid, tartaric acid, lactic acid, pyrrolidone carboxylic acid, pyron carboxylic acid, pyrrol carboxylic acid, furan carboxylic acid, viridin carboxylic acid, coumarin acid, thiophene carboxylic acid, nicotinic acid, oxysuccinic acid, and dioxysuccinic acid.

The reaction liquid may contain an appropriate amount of water or an organic solvent. The water used in this case can be water that has been deionized by ion exchange or the like. Further, the organic solvent that can be used in the reaction liquid is not particularly limited, and any known organic solvent can be used.

Various resins can also be added to the reaction liquid. For example, by adding an appropriate resin to the reaction liquid, it is possible to improve the adhesiveness of the intermediate image to the recording medium at the time of transfer and to increase the mechanical strength of the final image, which is preferable. The material used for this resin is not particularly limited as long as it can coexist with the ink high viscosity component.

Further, a surfactant or a viscosity adjusting agent can be added to the reaction liquid to use by appropriately adjusting the surface tension and viscosity thereof. The material used in this case is not particularly limited as long as it can coexist with the ink high viscosity component. Specific examples of the surfactant to be used include acetylenol E100 (trade name, manufactured by Kawaken Fine Chemicals Co., Ltd.). The surface energy of the reaction liquid is preferably adjusted to 50 mN/m or less, and more preferably 20 mN/m to 40 mN/m.

Further, the reaction liquid that can be used in the present invention can contain a fluorine-based surfactant. Here, the fluorine-based surfactant is a compound having at least a hydrophobic fluorocarbon chain and a hydrophilic molecular chain (hydrophilic portion) in the molecular structure. By having a hydrophobic fluorocarbon chain, it exhibits excellent ability to reduce surface tension as described above.

Among them, a nonionic surfactant having a fluoroalkyl chain as a hydrophobic portion and an ethylene oxide chain as a hydrophilic portion is particularly preferably used. Since it has a fluoroalkyl chain as a hydrophobic portion and an ethylene oxide chain as a hydrophilic portion, it is highly compatible with a solvent and a reactant, and therefore, exhibits excellent solubility even in a composition in which the water content is reduced due to drying or the like. Also, the uniformity of the reaction liquid layer and the ability to reduce surface tension can be maintained.

Further, in a case of a nonionic surfactant, the characteristics thereof can be maintained without structural change even after the reaction with the ink composition, so that the uniformity of the reaction liquid layer and the ability to reduce surface tension can be maintained.

Examples of the surfactant preferably used in this case include FSO100, FSN100, FS3100 (manufactured by DuPont), F444, F477, and F553 (manufactured by DIC). The surface energy of the reaction liquid can be adjusted to 20 mN/m or less.

The fluorine-based surfactant is preferably 1% by mass or more and 10% by mass or less with respect to the total mass of the reaction liquid. In a case where the content of the fluorine-based surfactant is small, the ability to reduce surface tension is reduced, and thus an average ratio R of a surface area per unit area of the surface of the transfer member can be increased. For example, in a case where the fluorine-based surfactant is 5% by weight, R is preferably 1.5 or more. Further, in a case where the fluorine-based surfactant is 1% by weight, R is preferably 1.7 or more.

### [Application of Reaction Liquid (Reaction Liquid Applying Step)]

In the reaction liquid applying step of applying the reaction liquid to the surface (image formation surface) of the transfer member, various known methods in the related art can be appropriately used. Specific examples thereof include die coating, blade coating, a method using a gravure roller, a method using an offset roller, and spray coating. In addition, a method of applying using an ink jet device is also suitable. Furthermore, it is very preferable to combine a plurality of several methods.

Further, for the purpose of improving the imparting property of the reaction liquid, improving the quality of the intermediate image, and improving the transfer efficiency, a step of applying a plurality of treatment solutions can be provided before the step of applying the reaction liquid.

### [Formation of Intermediate Image (Ink Applying Step)]

The intermediate image is formed by applying ink to the surface (image formation surface) of the transfer member. In the present specification, for convenience, the image from the formation of the reaction liquid and the ink on the surface of the transfer member to the final transfer to the recording medium is referred to as an “intermediate image”.

For example, an ink jet device can be used to apply the ink. Examples of the ink jet device include the following forms and the like.
A form in which the ink is ejected by causing film boiling of the ink with an electric-heat converter and forming bubbles,
A form in which ink is ejected by an electric-mechanical converter,
A form in which ink is ejected using static electricity.

As described above, any of the various ink jet devices proposed in the ink jet liquid ejection technology can be used. Among these, a form using an electric-heat converter is preferably used from the viewpoint of high-speed and high-density printing.

Further, the form of the entire ink jet device is not particularly limited. For example, the following ink jet heads can be used.
A so-called shuttle-type ink jet head that records while scanning a head perpendicular to the traveling direction of the transfer member.
A so-called line head type ink jet head in which ink ejection ports are arranged in a line substantially perpendicular to the traveling direction of the transfer member (that is, substantially parallel to the axial direction when the transfer member has a drum shape).

### (Ink)

In the following description, each component that can be used in the ink will be described.

### (1) Coloring Material

As inks, coloring materials in which a known dye, carbon black, an organic pigment, or the like is dissolved and/or dispersed can be used. Among these, various pigments are suitable because these are characterized in durability and quality of printed matter, and the ink can contain a pigment as a coloring material.

The pigment is not particularly limited, and known inorganic pigments and organic pigments can be used. Specifically, C.I. Pigments represented by (color index) numbers can be used. Carbon black also can be used as a black pigment. The content of the pigment in the ink is preferably 0.5% by mass or more and 15.0% by mass or less, and more preferably 1.0% by mass or more and 10.0% by mass or less with respect to the total mass of the ink.

### (2) Pigment Dispersant

As the pigment dispersant for dispersing the pigment, any known pigment dispersants in the related art used for an ink jet can be used. Among these, a water-soluble dispersant having both a hydrophilic portion and a hydrophobic portion in molecular structures thereof can be used. In particular, a pigment dispersant formed of a resin obtained by copolymerizing at least a hydrophilic monomer and a hydrophobic monomer can be used. There is no particular limitation on each monomer used here, and known ones in the related art are preferably used. Specific examples of the hydrophobic monomer include styrene, a styrene derivative, alkyl (meth)acrylate, and benzyl (meth)acrylate. Examples of the hydrophilic monomer include acrylic acid, methacrylic acid, and maleic acid. The acid value of the dispersant is preferably 50 mgKOH/g or more and 550 mgKOH/g or less. In addition, a weight average molecular weight of the dispersant is preferably 1000 or more and 50,000 or less. Note that, the mass ratio of the pigment to the dispersant in the ink is preferably in the range of 1:0.1 to 1:3.

Further, as another aspect of the ink, a so-called self-dispersing pigment in which the pigment itself is surface-modified to be dispersible can be used without using a dispersant.

### (3) Resin Fine Particle

The ink can contain various fine particles having no coloring material. Among these, the resin fine particle may be effective in improving image quality and fixability, which is preferable. The material of the resin fine particle is not particularly limited, and a known resin can be appropriately used. Specific examples thereof include polyolefin, polystyrene, polyurethane, polyester, polyether, polyurea, polyamide, polyvinyl alcohol, poly (meth)acrylic acid, and salts thereof. Further, homopolymers such as alkyl poly (meth)acrylate and polydiene, or copolymers obtained by combining a plurality of these homopolymers can be mentioned. A mass average molecular weight of the resin is preferably in the range of 1,000 or more and 2,000,000 or less. In addition, the content of the resin fine particles in the ink is preferably 1% by mass or more and 50% by mass or less, more preferably 2% by mass or more and 40% by mass or less, based on the total mass of the ink.

Further, the resin fine particles can be used as a resin fine particle dispersion dispersed in the ink. The method of dispersion is not particularly limited, but a so-called self-dispersion type resin fine particle dispersion in which a monomer having a dissociative group is dispersed by using a resin obtained by homopolymerizing or copolymerizing a plurality of kinds of monomers is preferable. Here, examples of the dissociative group include a carboxyl group, a sulfonic acid group, and a phosphoric acid group, and examples of the monomer having this dissociative group include acrylic acid and methacrylic acid. Further, a so-called emulsified dispersion type resin fine particle dispersion in which resin fine particles are dispersed by an emulsifier can also be preferably used. As the emulsifier referred to here, a known surfactant can be used regardless of the low molecular weight or the high molecular weight. The surfactant can be a nonionic surfactant or a surfactant having the same charge as that of the resin fine particle. The resin fine particle dispersion preferably has a dispersed particle size of 10 nm or more and 1000 nm or less, and more preferably 100 nm or more and 500 nm or less.

Various additives for stabilization can be added when producing the resin fine particle dispersion. As this additive, for example, n-hexadecan, dodecyl methacrylate, stearyl methacrylate, chlorobenzene, dodecyl mercaptan, olive oil, blue dye (Blue70), polymethyl methacrylate, and the like are suitable.

### (4) Surfactant

The ink may contain a surfactant. Specific examples of the surfactant include acetylenol EH (produced by Kawaken Fine Chemicals Co., Ltd.) and the like. The content of the surfactant in the ink is preferably 0.01% by mass or more and 5.0% by mass or less with respect to the total mass of the ink.

### (5) Water and Water-Soluble Organic Solvent

The ink can contain water and/or a water-soluble organic solvent as the solvent. The water can be water that has been deionized by ion exchange or the like. In addition, the content of water in the ink is preferably 30% by mass or more and 97% by mass or less with respect to the total mass of the ink. Further, the water-soluble organic solvent used in the ink is not particularly limited, and any known organic solvent can be used. Specific examples thereof include glycerin, diethylene glycol, polyethylene glycol, and 2-pyrrolidone. In addition, the content of water-soluble organic solvent in the ink is preferably 3% by mass or more and 70% by mass or less with respect to the total mass of the ink.

### (6) Other Additives

In addition to the above components, the ink may contain various additives such as a pH adjusting agent, a rust preventive, a preservative, a fungicide, an antioxidant, an anti-reduction agent, a water-soluble resin and a neutralizing agent thereof, and a viscosity adjusting agent, and the like, as necessary.

### (Transfer Auxiliary Liquid)

In the present invention, a transfer auxiliary liquid can be used in order to improve the transferability of the intermediate image. The transfer auxiliary liquid can be a component obtained by removing the coloring material from the above ink composition, that is, a so-called clear ink. By applying the clear ink on the transfer member after applying the ink of each color, the clear ink is present on the outermost surface of the ink image (intermediate image). In the transfer of the intermediate image to the recording medium, the clear ink on the surface of the intermediate image is adhered to the recording medium at a certain adhesive force, and thereby, the intermediate image after the liquid removal easily move to the recording medium. Such clear ink can be applied by the ink applying device 15. Further, units that separately applies the clear ink may be used.

### [Liquid Component Removing Step]

A step (liquid component removing step) of reducing liquid components from the intermediate image formed on the transfer member can be provided. If the liquid components of the intermediate image are excessive, the excess liquid may squeeze out or overflow in the transferring step, which may cause image distortion or transfer failure. As a method for removing the liquid component from the intermediate image, any of the various methods used in the related art can be suitably applied. For example, a method of heating, a method of blowing low-humidity air, a method of depressurizing, a method of contacting an absorber, and a method of combining these are all preferably used. In addition, it is also possible to carry out by natural drying.

### [Heating Step]

As a step following the ink applying step or the liquid component removing step, a heating step of heating the intermediate image on the surface of the transfer member by the heating step may be provided.

Examples of the heating device (heating unit) used in the heating step include a heating device that generates heat from a heater and the like and a heating device that irradiates infrared rays or near infrared rays.

This heating step may also serve as the liquid component removing step described above.

In a case of an intermediate image whose transferability is improved by heating, the intermediate image can be transferred by pressing against a recording medium in the transferring step in a state where the intermediate image is heated and the temperature (transfer temperature) is set to a temperature suitable for transfer.

The heating temperature is preferably 70° C. or higher and 120° C. or lower from the viewpoint of improving the transferability by heating the ink image and improving the durability of the transfer member by heat.

### [Transfer of Intermediate Image (Transferring Step)]

After the formation of the intermediate image, in the transferring step, the surface of the transfer member having the intermediate image is pressed against the recording medium, and the intermediate image is transferred to the recording medium to obtain the final image. In the present specification, the term “recording medium” includes not only paper used for general printing but also a wide range of cloth, plastic, film and other printing media, and recording media.

The method of pressing the transfer member and the recording medium is not particularly limited, but it is preferable to pressurize from both sides of the transfer member and the recording medium using a pressing roller from the viewpoint that the image is efficiently transferred and formed. Further, pressurizing in multiple steps may be effective in reducing transfer failure, which is preferable.

### [Cleaning Step]

As described above, in the image recording method of the present embodiment, the image formation is completed by application of the reaction liquid, the formation of the intermediate image by the application of the ink, the removal of the liquid component, the heating of the intermediate image, and the transfer of the intermediate image. However, the transfer member may be used repeatedly and continuously from the viewpoint of productivity, and in that case, the surface can be washed and regenerated before performing the next image formation. As a unit that washes and regenerating the transfer member, any of the various methods used in the related art can be suitably applied, and for example, any of the following methods can be used.
A method of showering a cleaning liquid on a surface of a transfer member.
A method of brining a Molton roller moistened with a cleaning liquid into contact with a surface of a transfer member and wiping off.
A method of bringing a surface of a transfer member into contact with a cleaning liquid surface.
A method of scraping a surface of a transfer member with a wiper blade.
A method of applying various energies to a surface of a transfer member.

Further, a method of combining a plurality of these methods is also suitable.

### [Fixing Step]

After the transfer, a fixing step for improving the fixability between the recording medium and the image by heating and pressurizing the recording medium on which the image is recorded may be performed. In addition, the heating of the recording medium may improve the fixability, and the heating of the recording medium is also suitable. Of course, these may be performed at the same time using a heating roller.

### <Image Recording Apparatus>

The image recording apparatus according to the present embodiment includes a transfer member, an intermediate image forming unit that forms an intermediate image on a surface of the transfer member, a heating unit that heats the intermediate image by heating the transfer member, and a transfer unit that transfers the heated intermediate image from the transfer member to a recording medium. The intermediate image forming unit includes a reaction liquid applying unit that applies a reaction liquid containing a component that increases the viscosity of the ink to the surface of the transfer member, and an ink applying unit that applies ink to the surface of the transfer member to form an intermediate image. Further, the reaction liquid applying unit may have a reaction liquid accommodating portion for accommodating the reaction liquid. Further, the ink applying unit may have an ink accommodating portion for accommodating ink.

FIG. 2 is a schematic view illustrating a schematic configuration of an image recording apparatus according to the present embodiment.

In FIG. 2, the image recording apparatus includes a transfer member 11 supported by a support member 12, a reaction liquid applying device 14 as a reaction liquid applying unit, an ink applying device 15 as an ink applying unit, a blower 16 as a liquid component removing unit, a heating device 17 as a heating unit, a pressing roller (pressing member) 19, and a cleaning device 20 as a cleaning unit.

As the transfer member 11, a transfer member having a configuration illustrated in FIG. 1 is used.

In FIG. 2, the transfer member 11 is disposed on an outer peripheral surface of a rotatable drum-shaped support member 12. The transfer member 11 is rotationally driven around a rotation axis 13 in the direction of the arrow, and in synchronization with the rotation, each device arranged in the vicinity thereof operates to form an intermediate image and the final image to a recording medium by transfer. When the drum-shaped transfer member 11 as in the present embodiment is used, it becomes easy to use the same transfer member 11 continuously and repeatedly, and the configuration is very suitable from the viewpoint of the productivity. The intermediate image forming unit in the present embodiment includes the reaction liquid applying device 14 and the ink applying device 15. As the reaction liquid applying device 14 (14a: reaction liquid, 14b, 14c: reaction liquid application roller), a reaction liquid applying device having a roll coater is provided. As the ink applying device, an ink jet device provided with an ink jet recording head is provided. These devices are arranged in this order from upstream to downstream in the rotation direction of the transfer member 11, and the reaction liquid is applied to the image formation surface of the transfer member 11 before the ink is applied.

The ink jet device may include a plurality of ink jet recording heads. For example, in a case where each color image is formed by using yellow ink, magenta ink, cyan ink, and black ink, the ink jet device has four ink jet recording heads that eject the above four types of ink onto the transfer member.

The blower 16 is provided for a liquid removing process for removing at least a part of the liquid component from the intermediate image by blowing air to the intermediate image.

The heating device 17 may be a heater provided inside the support member 12, and the heating device 17 can heat the intermediate image from the image formation surface side of the transfer member 11.

A pair of pressing rollers for transfer is formed of the pressing roller 19 and the drum-shaped support member 12. By allowing the recording medium 18 overlapped on the image formation surface having the intermediate image of the transfer member 11 to pass through a nip portion formed by an outer peripheral surface of the pressing roller 19 and the outer peripheral surface of the drum-shaped support member 12 in contact with each other, the intermediate image can be pressed and transferred to the recording medium 18. The temperature at the time of transfer is given by the heating device 17. In the present embodiment, the transfer unit is formed of the pressing roller 19 as a pressing member for transfer and the support member 12 of the transfer member 11.

The cleaning device 20 (20a: cleaning liquid, 20b, 20c: cleaning roller) cleans the surface of the transfer member 11 before forming the next intermediate image in a case where the transfer member 11 is used repeatedly and continuously. In the present embodiment, the cleaning device for cleaning the image formation surface is provided by bringing a Molton roller moistened with a cleaning liquid into contact with the image formation surface of the transfer member and wiping off.

According to the present invention, it is possible to provide a transfer member having excellent transferability of an intermediate image to a recording medium and improved durability, and an image recording apparatus using the transfer member and an image recording method.

### EXAMPLES

In the following description, the present invention will be described in more detail with reference to examples and comparative examples of the transfer member and the image recording method. Note that, the present invention is not limited to the following examples as long as the gist of the present invention is not exceeded. In addition, “part” or “%” regarding the composition of each material is based on mass unless otherwise specified.

The transfer member has a layer structure illustrated in FIG. 1, and was produced by laminating a base layer (not shown), a compression layer 104, an intermediate layer 103, an elastic layer 102, and a surface layer 101 in this order. Further, according to Table 1, transfer members having the physical properties indicated in Examples 1 to 22 and Comparative Examples 1 to 3 were produced. In Examples 1 to 13 and Comparative Examples 1 and 3, transfer members including an elastic layer, a compression layer, and a base layer were produced. In Examples 14 to 16 and Comparative Example 2, a transfer member including an elastic layer, an intermediate layer, a compression layer, and a base layer was produced. In Examples 17 to 21, transfer members including a surface layer, an elastic layer, an intermediate layer, a compression layer, and a base layer were produced. In Example 22, a transfer member including a surface layer, an elastic layer, a compression layer, and a base layer were produced.

### (Base Layer)

A base material was produced by laminating a first base layer in which cotton yarn was woven, a rubber sponge layer having acrylonitrile rubber, and a second base layer in which cotton yarn was woven in this order using an adhesive.

### (Compression Layer)

Unvulcanized silicone rubber mixed with hollow fine particles having an average particle size of about 60 μm was mixed with a vacuum stirring defoamer on the surface of the base material on the second base layer side, the mixture having a thickness of 0.3 mm was coated using a knife coater, and then vulcanization was performed to form a compression layer.

### (Intermediate Layer)

As the intermediate layer, a polyimide film (UPIREX S, produced by Ube Industries, Ltd.) was used in Example 14, a polyester film (Lumirer S10, produced by Toray Industries, Inc.) was used in Examples 15 to 21, and a polyethylene film (produced by Taiyo Plastics Co., Ltd.) was used in Comparative Example 2.

### (Elastic Layer)

A black masterbatch for silicone rubber containing carbon black was added to the silicone rubber at a ratio of 5% by mass, and the thermally conductive filler indicated in Table 1 was further added and mixed by a vacuum stirring defoamer. The obtained mixture was vulcanized to form an elastic layer.

### (Surface Layer)

Glycidoxypropyl triethoxy silane and methyl triethoxy silane were mixed at an optional ratio and heated under reflux in an aqueous solvent for 24 hours or more to obtain a solution containing a condensate obtained by condensing an organosilicon compound. This solution was diluted to 12% by mass with methyl isobutyl ketone, 5% by mass of a photocationic polymerization initiator SP150 (produced by ADEKA) was added with respect to the solid content, and the concentration was adjusted to an optional concentration with methyl isobutyl ketone so as to make a coating liquid. The coating liquid was applied onto a plasma-treated elastic layer to form a film. Next, after irradiation with a UV lamp (ultraviolet lamp) and exposure, the mixture was heated at 150° C. for 2 hours and cured to form a surface layer to obtain a transfer member.

The materials constituting each layer were bonded by applying a toluene solution of silicone rubber and acrylonitrile rubber and pressurizing the coated materials.

The physical properties of each layer constituting the transfer member were determined by the following method.

### (1) Thickness

The thickness of each layer constituting the transfer member was measured by cutting out the transfer member to an optional size and observing the cross section thereof. This thickness is a value obtained by measuring the thickness of any 10 points selected so as not to be biased an electron microscope, and averaging these measured values.

### (2) Compressive Elastic Modulus

The compressive elastic modulus is a value measured in accordance with JIS K 7181 using a viscoelastic spectrometer (product name: DMS6100, Hitachi High-Tech Science Corporation).

### (3) Thermal Conductivity

The thermal conductivity was determined by preparing a test piece for measurement using the constituent materials of each layer and measuring it with a hot disk method thermophysical property measuring device (product name: TPS2500S, Kyoto Electronics Manufacturing Co., Ltd.).

TABLE 1

| | Surface layer | | | Elastic layer | | | |
|---|---|---|---|---|---|---|---|
| | Compressive | | | Compressive | | | Thermally |
| | elastic | Thermal | | elastic | Thermal | | conductive |
| | modulus | conductivity | Thickness | modulus | conductivity | Thickness | filler |
| | MPa | W/m · K | mm | MPa | W/m · K | mm | — |
| Example 1 | — | — | — | 15 | 0.70 | 0.10 | Metallic silicon |
| Example 2 | — | — | — | 50 | 1.50 | 0.10 | Metallic silicon |
| Example 3 | — | — | — | 30 | 1.00 | 0.10 | Metallic silicon |
| Example 4 | — | — | — | 10 | 0.50 | 0.10 | Metallic silicon |
| Example 5 | — | — | — | 15 | 0.70 | 0.10 | Metallic silicon |
| Example 6 | — | — | — | 15 | 0.70 | 0.10 | Metallic silicon |
| Example 7 | — | — | — | 15 | 0.70 | 0.10 | Metallic silicon |
| Example 8 | — | — | — | 15 | 0.70 | 0.05 | Metallic silicon |
| Example 9 | — | — | — | 15 | 0.70 | 0.20 | Metallic silicon |
| Example 10 | — | — | — | 15 | 0.70 | 0.10 | Metallic silicon |
| Example 11 | — | — | — | 15 | 0.70 | 0.10 | Metallic silicon |
| Example 12 | — | — | — | 15 | 0.70 | 0.10 | Alumina |
| Example 13 | — | — | — | 15 | 0.25 | 0.10 | Metallic silicon |
| Example 14 | — | — | — | 15 | 0.70 | 0.10 | Metallic silicon |
| Example 15 | — | — | — | 15 | 0.70 | 0.10 | Metallic silicon |
| Example 16 | — | — | — | 15 | 0.70 | 0.10 | Metallic silicon |
| Example 17 | 10 | 0.25 | 0.005 | 15 | 0.70 | 0.10 | Metallic silicon |
| Example 18 | 100 | 0.22 | 0.005 | 15 | 0.70 | 0.10 | Metallic silicon |
| Example 19 | 300 | 0.20 | 0.005 | 15 | 0.70 | 0.10 | Metallic silicon |
| Example 20 | 100 | 0.22 | 0.001 | 15 | 0.70 | 0.10 | Metallic silicon |
| Example 21 | 100 | 0.22 | 0.010 | 15 | 0.70 | 0.10 | Metallic silicon |
| Example 22 | 100 | 0.22 | 0.007 | 15 | 0.70 | 0.10 | Metallic silicon |
| Comparative | — | — | — | 5 | 0.20 | 0.15 | — |
| Example 1 | | | | | | | |
| Comparative | — | — | — | 100 | 0.20 | 0.30 | — |
| Example 2 | | | | | | | |
| Comparative | — | — | — | 15 | 0.70 | 0.10 | Metallic silicon |
| Example 3 | | | | | | | |
| | | Intermediate layer | | | Compression layer | | |
| | Elastic layer | Compressive | | | Compressive | | |
| | Content | elastic | Thermal | | elastic | Thermal | |
| | % by | modulus | conductivity | Thickness | modulus | conductivity | Thickness |
| | mass | MPa | W/m · K | mm | MPa | W/m · K | mm |
| Example 1 | 45 | — | — | — | 3 | 0.15 | 0.40 |
| Example 2 | 60 | — | — | — | 3 | 0.15 | 0.40 |
| Example 3 | 50 | — | — | — | 3 | 0.15 | 0.40 |
| Example 4 | 35 | — | — | — | 3 | 0.15 | 0.40 |
| Example 5 | 45 | — | — | — | 10 | 0.18 | 0.40 |
| Example 6 | 45 | — | — | — | 5 | 0.16 | 0.40 |
| Example 7 | 45 | — | — | — | 1 | 0.10 | 0.40 |
| Example 8 | 45 | — | — | — | 3 | 0.15 | 0.40 |
| Example 9 | 45 | — | — | — | 3 | 0.15 | 0.40 |
| Example 10 | 45 | — | — | — | 3 | 0.15 | 0.20 |
| Example 11 | 45 | — | — | — | 3 | 0.15 | 0.60 |
| Example 12 | 45 | — | — | — | 3 | 0.15 | 0.40 |
| Example 13 | 10 | — | — | — | 3 | 0.15 | 0.40 |
| Example 14 | 45 | 6000 | 0.15 | 0.025 | 3 | 0.15 | 0.40 |
| Example 15 | 45 | 4000 | 0.25 | 0.005 | 3 | 0.15 | 0.40 |
| Example 16 | 45 | 4000 | 0.25 | 0.050 | 3 | 0.15 | 0.40 |
| Example 17 | 45 | 4000 | 0.25 | 0.025 | 3 | 0.15 | 0.40 |
| Example 18 | 45 | 4000 | 0.25 | 0.025 | 3 | 0.15 | 0.40 |
| Example 19 | 45 | 4000 | 0.25 | 0.025 | 3 | 0.15 | 0.40 |
| Example 20 | 45 | 4000 | 0.25 | 0.025 | 3 | 0.15 | 0.40 |
| Example 21 | 45 | 4000 | 0.25 | 0.025 | 3 | 0.15 | 0.40 |
| Example 22 | 45 | — | — | — | 3 | 0.15 | 0.40 |
| Comparative | — | — | — | — | 3 | 0.15 | 0.40 |
| Example 1 | | | | | | | |
| Comparative | — | 30 | 0.20 | 0.05 | 3 | 0.15 | 0.40 |
| Example 2 | | | | | | | |
| Comparative | 45 | — | — | — | 50 | 0.20 | 1.00 |
| Example 3 | | | | | | | |

The reaction liquid and ink used in this example were prepared as follows.

### (Preparation of Reaction Liquid)

Each of the following components was mixed and sufficiently stirred, and then pressure filtration was performed with a cellulose acetate filter (manufactured by Advantech) having a pore size of 3.0 μm to prepare a reaction liquid.
Levulinic acid: 40.0 parts
Glycerin: 5.0 parts
Surfactant (trade name: Megafac F444, produced by DIC): 1.0 parts
Ion-exchanged water: 54.0 parts

Next, the ink of each color and the transfer auxiliary liquid were applied in this order to the surface of the transfer member to which the reaction liquid was applied by an ink jet recording head provided so as to face the surface of the transfer member. The preparation method and composition of the ink and the transfer auxiliary liquid are as indicated in Table 2. Note that, pigments were used for the ink of each color.

### <Preparation of Resin Particle>

18.0 parts of butyl methacrylate, 2.0 parts of a polymerization initiator (2,2′-azobis (2-methylbutyronitrile)), and 2.0 parts of n-hexadecane were added in a four-necked flask equipped with a stirrer, a reflux cooling device, and a nitrogen gas introduction tube. Then, nitrogen gas was introduced into the reaction system, and the mixture was stirred for 0.5 hours. 78.0 parts of a 6.0% aqueous solution of an emulsifier (trade name: NIKKOL BC15, produced by Nikko Chemicals Co., Ltd.) was added dropwise to this flask, and the mixture was stirred for 0.5 hours. Then, the mixture was then emulsified by irradiating the mixture with ultrasonic waves for 3 hours with an ultrasonic irradiator. Then, the polymerization reaction was carried out at 80° C. for 4 hours in a nitrogen atmosphere. After cooling the reaction system to 25° C., the components are filtered and an appropriate amount of pure water is added to prepare an aqueous dispersion of a resin particle 1 having a resin particle 1 (solid content) content of 20.0%.

### <Preparation of Aqueous Resin Solution>

A styrene-ethyl acrylate-acrylic acid copolymer (resin 1) having an acid value of 150 mgKOH/g and a weight average molecular weight of 8,000 was prepared. 20.0 parts of resin 1 was neutralized with equimolar potassium hydroxide to the acid value thereof, an appropriate amount of pure water was added, so that an aqueous solution of resin 1 having a resin (solid content) content of 20.0% was prepared.

### <Preparation of Ink>

### (Preparation of Pigment Dispersion)

10.0 parts of pigment (carbon black), 15.0 parts of an aqueous solution of resin 1, and 75.0 parts of pure water were mixed. This mixture and 200 parts of zirconia beads having a diameter of 0.3 mm were placed in a batch type vertical sand mill (manufactured by Imex Co., Ltd.) and dispersed for 5 hours while cooling with water. Then, the resultant was centrifuged to remove coarse particles, and pressure-filtered with a cellulose acetate filter (manufactured by Advantech) having a pore size of 3.0 so as to prepare a pigment dispersion K having a pigment content of 10.0% and a resin dispersant (resin 1) content of 3.0%.

### (Preparation of Ink)

Each component (unit: portion) indicated in Table 2 below was mixed and sufficiently stirred, and then pressure filtration was performed with a cellulose acetate filter (manufactured by Advantech) having a pore size of 3.0 μm to prepare black ink. Acetylenol E100 (trade name) is a surfactant produced by Kawaken Fine Chemicals Co., Ltd.

TABLE 2

| | Black |
|---|---|
| | ink |
| Pigment dispersion K | 20.0 |
| Aqueous dispersion of resin particle 1 | 50.0 |
| Aqueous solution of resin 1 | 5.0 |
| Glycerin | 5.0 |
| Diethylene glycol | 7.0 |
| Acetylenol E100 | 0.5 |
| Ion-exchanged water | 12.5 |

### <Preparation of Transfer Auxiliary Liquid>

Each of the following components was mixed and sufficiently stirred, and then pressure filtration was performed with a cellulose acetate filter (manufactured by Advantech) having a pore size of 3.0 μm to prepare a transfer auxiliary liquid.
Aqueous dispersion of resin particle 1: 30.0%
Aqueous solution of resin 1: 3.0%
Glycerin: 5.0%
Diethylene glycol: 4.0%
Acetylenol E100 (trade name, surfactant, produced by Kawaken Fine Chemicals Co., Ltd.): 1.0%
Ion-exchanged water: 57.0%

### (Image Recording Apparatus and Image Recording Method)

Image formation was performed using the image recording apparatus illustrated in FIG. 2. As the support member 12 of the transfer member 11, a cylindrical drum made of an aluminum alloy was used. As a result, it is possible to satisfy required characteristics such as rigidity and dimensional accuracy that can withstand pressure during transfer, reduction of rotational inertia, and improvement of control responsiveness.

As illustrated in FIG. 2, the transfer member 11 produced by the above method was installed on the outer peripheral surface of the support member 12. Next, when forming an image, first, the reaction liquid was applied onto the surface of the transfer member 11 by the reaction liquid applying device 14 while rotating the transfer member 11 in the direction of the arrow in FIG. 2. Next, the ink (including the transfer auxiliary liquid) was ejected from the ink applying device 15 onto the surface of the transfer member. As a result, the reaction liquid and the ink react with each other on the surface of the transfer member 11 to form an intermediate image. After the intermediate image was formed, the moisture in the intermediate image was removed by a heater (not shown) and a blower 16 built in the support member 12 of the transfer member 11. Next, as the transfer member rotates, the intermediate image passes between the transfer member and a pressing roller 19. In this case, the intermediate image is pressed against the recording medium 18, the intermediate image is transferred onto the recording medium 18 from the transfer member. The surface of the transfer member after the transfer of the intermediate image is cleaned and purified by the cleaning device 20. By repeating the above operation with the rotation of the transfer member, image recording is repeatedly performed. The transfer member surface temperature in the intermediate image forming step was 60° C., and the transfer member surface temperature immediately before the intermediate image transferring step was 120° C.

As an ejection pattern of the intermediate image, a 100% solid pattern in which a solid image having a recording duty of 100% was formed in a range of 1 cm×1 cm was used. In the image recording apparatus, a recording duty is defined as 100% under the condition that one drop of 4 ng of ink is applied to a unit area of 1/1,200 inch×1/1,200 inch at a resolution of 1,200 dpi×1,200 dpi.

After that, the transfer member and the intermediate image were heated by the heating device 17 provided so as to face the surface of the transfer member. Note that a warm air heater was used as the heating device. Next, the intermediate image was pressed against the transfer member 11 by the pressing roller 19, and the image was transferred onto the recording medium 18. As the recording medium, a recording medium A (Aurora Coat (trade name), Nippon Paper Industries Co., Ltd., basis weight of 73.5 g/m²) and a recording medium B (OK Prince High Quality (trade name), Oji Paper Co., Ltd., basis weight of 73.5 g/m²) were used.

The temperature of the surface of the transfer member, in a state of being heated by the heating device 17, in a state where immediately before the recording medium 18 is brought into contact with the surface of the transfer and pressed by the pressing roller, and in a state where immediately after the recording medium pressed by the pressing roller was peeled off, was measured using a radiation thermometer.

After cleaning the transfer member, the same image recording process was repeated 10,000 times, and the transferability of the first and 10,000th images was evaluated according to the following criteria.

3: Transfer rate to recording medium is 90% or more

2: Transfer rate to recording medium is 70% or more and less than 90%

1: Transfer rate to recording medium is less than 70%

The transfer member after the transferring step was observed with an optical microscope to determine the remaining area of the intermediate image, and calculate the transfer rate to the recording medium by using a formula of [100-(remaining area of intermediate image)/(area of intermediate image)].

Further, the surface of the transfer member after 10,000 times of image recording was observed with an optical microscope, and the following durability was used as a reference.

3: No damage such as cracks can be seen in an observation range.

2: A small number of damages such as cracks can be seen in the observation range.

1: Many damages such as cracks can be seen in the observation range.

Table 3 indicates the evaluation results of the transferability to the recording medium and the durability of the transfer member.

TABLE 3

| | Transferability | | |
|---|---|---|---|
| | Recording | Recording | |
| | medium A | medium B | Durability |
| Example 1 | 3 | 3 | 2 |
| Example 2 | 3 | 2 | 2 |
| Example 3 | 3 | 2 | 2 |
| Example 4 | 3 | 2 | 2 |
| Example 5 | 3 | 3 | 2 |
| Example 6 | 3 | 2 | 2 |
| Example 7 | 3 | 2 | 2 |
| Example 8 | 3 | 2 | 2 |
| Example 9 | 3 | 2 | 2 |
| Example 10 | 3 | 3 | 2 |
| Example 11 | 3 | 2 | 2 |
| Example 12 | 3 | 3 | 2 |
| Example 13 | 3 | 3 | 2 |
| Example 14 | 3 | 2 | 2 |
| Example 15 | 3 | 2 | 2 |
| Example 16 | 3 | 2 | 2 |
| Example 17 | 3 | 2 | 3 |
| Example 18 | 3 | 2 | 3 |
| Example 19 | 3 | 2 | 3 |
| Example 20 | 3 | 2 | 3 |
| Example 21 | 3 | 2 | 3 |
| Example 22 | 3 | 2 | 3 |
| Comparative | 3 | 2 | 1 |
| Example 1 | | | |
| Comparative | 2 | 1 | 2 |
| Example 2 | | | |
| Comparative | 3 | 2 | 1 |
| Example 3 | | | |

From Table 3, it can be seen that the image recording apparatus and the image recording method of the present invention have the excellent transferability, and the transfer member of the present invention has the excellent durability.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-010861, filed Jan. 27, 2020, and Japanese Patent Application No. 2021-007993, filed Jan. 21, 2021, which are hereby incorporated by reference herein in their entirety.

What is claimed is:

1. A transfer member comprising:
an elastic layer; and
a compression layer,
wherein the elastic layer contains a thermally conductive filler having thermal conductivity of 5 [W/m·K] or more, and
when a compressive elastic modulus of the elastic layer is defined as E1 [MPa], thermal conductivity of the elastic layer is defined as λ1 [W/m·K], a compressive elastic modulus of the compression layer is defined as E2 [MPa], and thermal conductivity of the compression layer is defined as λ2 [W/m·K], 1≤E1≤50, E2≤10, 0.25≤λ1, and λ2≤0.2 are satisfied.

2. The transfer member according to claim 1,
wherein when a thickness of the elastic layer is defined as t1 [mm] and a thickness of the compression layer is defined as t2 [mm], 0.03≤t1≤0.2 and 0.1≤t2≤0.6 are satisfied.

3. The transfer member according to claim 1,
wherein the thermally conductive filler contains metallic silicon.

4. The transfer member according to claim 1,
wherein the thermally conductive filler contains alumina.

5. The transfer member according to claim 1,
wherein the elastic layer contains the thermally conductive filler in an amount of 1% by mass or more and 70% by mass or less based on a total mass of the elastic layer.

6. The transfer member according to claim 1, further comprising:
an intermediate layer between the elastic layer and the compression layer,
wherein in the intermediate layer, when a compressive elastic modulus is defined as E3 [MPa], thermal conductivity is defined as λ3 [W/m·K], and a thickness is defined as t3 [mm], 1000≤E3≤7000, 0.1≤λ3≤0.5, and 0.003≤t3≤0.05 are satisfied.

7. The transfer member according to claim 1, comprising:
a surface layer on a surface forming an intermediate image of the elastic layer,
wherein in the surface layer, when a compressive elastic modulus is defined as E4 [MPa], thermal conductivity is defined as λ4 [W/m·K], and a thickness is defined as t4 [mm], 10≤E4≤300, 0.1≤λ 4≤0.5, and 0.001≤t4≤0.015 are satisfied.

8. The transfer member according to claim 1, further comprising:
a base layer on a surface of the compression layer opposite to a surface facing the elastic layer.

9. The transfer member according to claim 8,
wherein the base layer contains at least one selected from the group consisting of a woven fabric containing cellulose fibers and a non-woven fabric containing cellulose fibers.

10. The transfer member according to claim 1,
wherein the transfer member is a transfer member used in an image recording method in which an intermediate image is formed on a surface, a temperature of the intermediate image is controlled by a heating unit, and the intermediate image is transferred to a recording medium.

11. An image recording apparatus comprising:
a transfer member;
an intermediate image forming unit that forms an intermediate image on a surface of the transfer member;
a heating unit that heats the intermediate image by heating the transfer member; and
a transfer unit that transfers the heated intermediate image from the transfer member to a recording medium,
wherein the transfer member has an elastic layer and a compression layer,
the elastic layer contains a thermally conductive filler having thermal conductivity of 5 [W/m·K] or more, and
when a compressive elastic modulus of the elastic layer is defined as E1 [MPa], thermal conductivity of the elastic layer is defined as λ1 [W/m·K], a compressive elastic modulus of the compression layer is defined as E2 [MPa], and thermal conductivity of the compression layer is defined as λ2 [W/m·K], 1≤E1≤50, E2≤10, 0.25≤λ1, and λ2≤0.2 are satisfied.

12. An image recording method comprising:
forming an intermediate image on a surface of the transfer member;
heating the intermediate image by heating the transfer member; and
transferring the heated intermediate image from the transfer member to a recording medium,
wherein the transfer member has an elastic layer and a compression layer,
the elastic layer contains a thermally conductive filler having thermal conductivity of 5 [W/m·K] or more, and
when a compressive elastic modulus of the elastic layer is defined as E1 [MPa], thermal conductivity of the elastic layer is defined as λ1 [W/m·K], a compressive elastic modulus of the compression layer is defined as E2 [MPa], and thermal conductivity of the compression layer is defined as λ2 [W/m·K], 1≤E1≤50, E2≤10, 0.25≤λ1, and λ2≤0.2 are satisfied.
